(19) United States
(12) Patent Application Publication
(10) Pub. No.: US 2018/0155111 A1
(43) Pub. Date: Jun. 7, 2018

(54) DISPENSING CARTON

(71) Applicant: CareZone Inc., San Francisco, CA (US)

(72) Inventors: Brittany Ann STATEN, San Francisco, CA (US); Laia Pose Gratacos, San Francisco, CA (US)

(21) Appl. No.: 15/369,558

(22) Filed: Dec. 5, 2016

(51) Int. Cl. B65D 83/08; A61J 7/00; B65D 5/02; B65D 5/72

(52) U.S. Cl. CPC B65D 83/0805; B65D 5/725; B65D 5/0227; A61J 7/0084

(57) ABSTRACT

A dispensing carton is provided. The dispensing carton can include a plurality of panels that at least partially surround an interior of the carton. The carton can include a dispensing opening. The carton can include a privacy panel to at least partially cover a panel of the carton. The carton can also include a retention member to keep hold of an end of a dispensing roll positioned within an interior area of the carton.

### BACKGROUND

### Field

Embodiments of the present invention relate to a carton for holding and dispensing articles, for example, dispensing packets of prepackaged consumables formed into a roll.

### Background

Many individuals take daily medications and supplements, often numerous different pills at varying times of the day. Management of administration and ingestion of these daily medications and supplements is a challenge, especially when a consumer manages their own care and regimen by sorting through doctor instructions and many containers.

To simplify medication and supplement intake for a consumer, medication and supplement pills can be pre-sorted and pre-packaged into individual packets. Each individual packet can be labeled to indicate the contents of the packet along with instructions and/or drug warnings. The contents of each individual packet can be consumed together. These individual packets can be formed together in a long strip that can formed into a roll that can be used with a dispensing carton.

### BRIEF SUMMARY OF THE INVENTION

One aspect of the invention provides a dispensing carton suitable for dispensing a roll. The roll can be formed from a long strip of individually packaged consumables. The dispensing carton can include a privacy panel to cover at least a portion of an exterior panel of the dispensing carton containing ingredient labels, warnings, and/or usage instructions related to the consumables contained therein. The dispensing carton can also include a retention member, such as a tab, to keep hold of an end of the roll of consumables. The retention member can prevent the end of the roll from falling into the interior area of the dispensing carton.

In an aspect of the invention, a dispensing carton can be formed from a blank and can include a front panel, a back panel, a top panel, a first side panel, a second side panel, and a bottom flap, the front panel, back panel, top panel, first side panel, second side panel, and bottom flap can extend at least partially around an interior of the carton. A dispensing slot can be formed in one of the front panel, back panel, and top panel, A retention member can be formed in one of the front panel, back panel, and top panel. The front panel can be foldably attached to the first side panel and the second side panel. The back panel can be foldably attached to the second side panel. The top panel can be foldably attached to the first side panel.

In another aspect, a carton blank can include a top panel, a first side panel connected to the top panel by a first longitudinal fold line, a front panel connected to the first side panel by a first transverse fold line, a second side panel connected to the front panel by a second transverse fold line, a back panel connected to the second side panel by a third transverse fold line, a dispensing slot formed in one of the top panel, front panel, and back panel, and a cut line in one of the top panel, front panel, and back panel, the cut line forming a retention member to hold an end of a dispensing roll.

In a further aspect, a carton blank can include a top panel, a first side panel connected to the top panel by a first longitudinal fold line, a front panel connected to the first side panel by a first transverse fold line, a second side panel connected to the front panel by a second transverse fold line, a back panel connected to the second side panel by a third transverse fold line, a dispensing slot formed in the front panel, a cut line in the top panel, the cut line forming a retention member to hold an end of a dispensing roll, a privacy panel connected to the back panel by a fourth transverse fold line, a privacy panel flap connected to the privacy panel by a fifth transverse fold line, and a privacy panel slot formed along a portion of the first transverse fold line.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a perspective view of a dispensing carton and roll of consumables according to various aspects of the invention.

FIG. 2 is a perspective view of a dispensing carton according to various aspects of the invention.

FIG. 3 is a perspective view of a dispensing carton according to various aspects of the invention.

FIG. 4 is a top view of a dispensing carton according to various aspects of the invention.

FIG. 5 is a bottom view of a dispensing carton according to various aspects of the invention.

FIG. 6. is a plan view of a blank used to form a dispensing carton according to various aspects of the invention.

Features and advantages of the embodiments will become more apparent from the detailed description set forth below when taken in conjunction with the drawings, in which like reference characters identify corresponding elements throughout.

### DETAILED DESCRIPTION OF THE INVENTION

The present invention(s) will now be described in detail with reference to embodiments thereof as illustrated in the accompanying drawings. References to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention generally relates to cartons that contain articles such as a roll of consumables in individual packets. The consumables can be for example, medications and/or supplements. The roll of consumables can be made from materials suitable in composition for packaging the particular consumables, including plastics such as PET, LDPE, LLDPE, HDPE, PP, PS, PVC, EVOH, and Nylon; and the like, or any combination thereof.

Cartons according to the present invention can accommodate articles, or subsets of articles, of any shape. For the purpose of illustration and not for the purpose of limiting the scope of the invention, the following detailed description describes a roll as disposed within the carton embodiments. In this specification, the terms “lower,” “bottom,” “upper” and “top” indicate orientations determined in relation to fully erected and upright cartons.

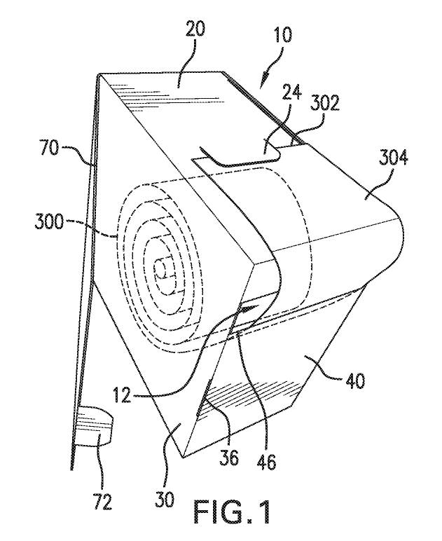

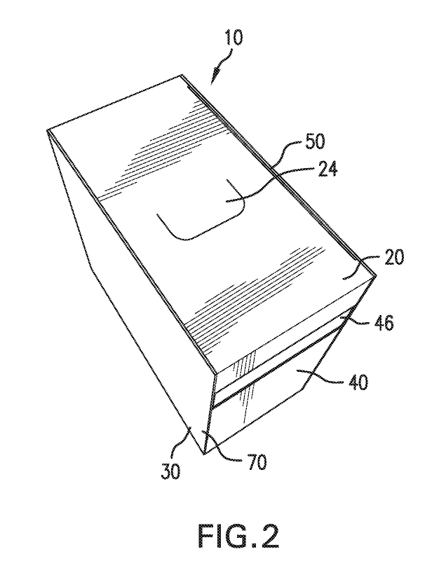

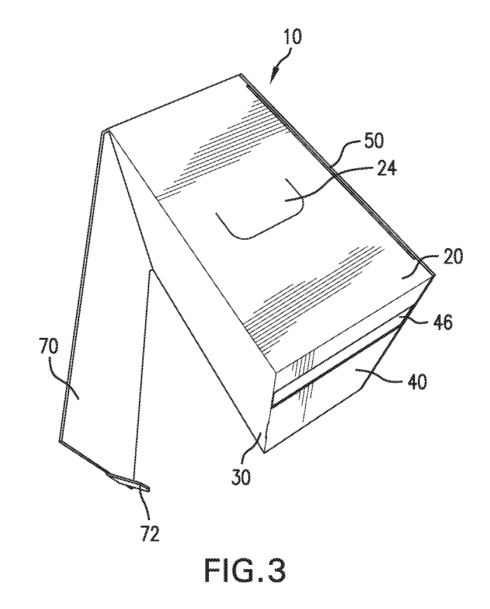

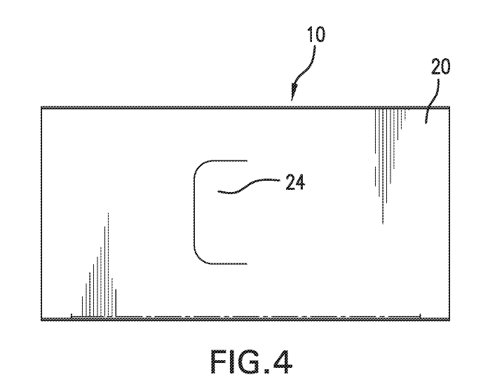

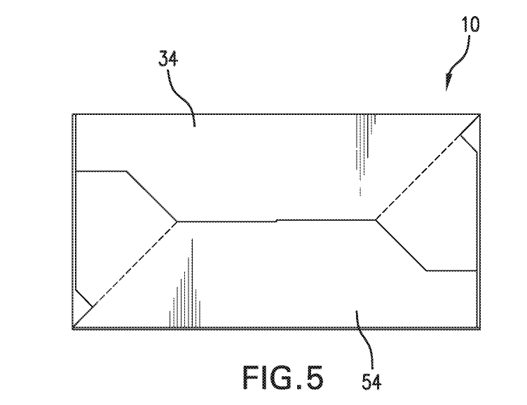

An aspect of the present invention will now be described with reference to FIGS. 1-5. Dispensing carton 10 can include a top panel 20, a first side panel 30, a front panel 40, a second side panel 50 (FIG. and a first bottom flap 34 and a second bottom flap 54 (FIG. 5). In one aspect, dispensing carton 10 can be a rectangular prism. In other aspects, dispensing carton 10 can for example, be a cube or cuboid.

Top panel 20, first side panel 30, front panel 40, back panel 60, second side panel 50, first bottom flap 34, and second bottom flap 54 of dispensing carton 10 can surround an interior area 12. Articles to be dispensed from dispensing carton 10 can be positioned within interior area 12. For example, a dispensing roll 300 can be positioned within interior area 12, as shown in FIG. 1. Dispensing roll 300 can be formed from a long strip of packets 304. Each packet 304 can include for example, individually packaged consumables, such as medication and/or supplements.

Dispensing carton 10 can include a dispensing slot 46 formed in front panel 40. A roll end 302 of dispensing roll 300 can extend from interior area 12 through dispensing slot 46 to provide packet 304 to a consumer (FIG. 1).

In another aspect of the invention, dispensing slot 46 can be formed in one or more of the top panel 20, back panel 60, first side panel 30, and/or second side panel 50. In a further aspect, two or more dispensing slots 46 can be formed in one or more of front panel 40, top panel 20, back panel 60, first side panel 30, and/or second side panel 50.

In another aspect, multiple dispensing rolls 300 can be positioned within interior area 12. Each of the dispensing rolls 300 can extend through a single dispensing slot 46. In another aspect where dispensing carton 10 includes two or more dispensing slots 46, each of the dispensing rolls 300 can extend through a separate dispensing slot 46.

Dispensing carton 10 can include a retention tab member 24, for example, a tab, integrally formed in top panel 20 to hold roll end 302 in position making it easier for a consumer to access packet 304 (FIG. 1). Retention member 24 can also prevent roll end 302 from falling through dispensing slot 46 into interior area 12. For example, retention member 24 can exert a normal force on dispenser roll 300 at roll end 302 to push roll end 302 against top panel 20. The friction between retention member 24, top panel 20, and roll end 302 can hold roll end 302 in position and prevent roll end 302 from falling into interior area 12.

In an aspect, retention member can be formed in the same panel as dispensing slot 46 and positioned adjacent to dispensing slot 46. In another aspect, retention member 24 can be formed in a panel of dispensing carton 10 adjacent to the panel including dispensing slot 46. For example, retention member 24 can be formed in top panel 20 when dispensing slot 46 is formed in front panel 40.

Dispensing carton 10 can include a privacy panel 70 to cover at least a portion of an exterior panel of dispensing carton 10 that contains ingredient labels, warnings, and/or usage instructions related to one or more of the consumables contained in one or more packet 304. For example, privacy panel 70 can cover at least a portion of one or more of first side panel 30 and/or second side panel 50. Privacy panel 70 can be integrally formed with dispensing carton 10. As shown in FIG. 1, privacy panel 70 can include a privacy flap 72 to fit within privacy flap slot 36 to selectively retain privacy panel 70 against first side panel 30.

Dispensing carton 10 can be sized to fit in a two pound dimensional weight package. Dimensional weight (in lbs.) is determined by the package cubic size in inches by 166, or the length×width×height divided by 166. In an aspect, dispensing carton 10 can be sized to fit in a package having a length of approximately 5 inches, a width of approximately 7.25 inches, and a height of approximately 7 inches. In another embodiment, can be sized to fit in a three pound dimensional weight package. For example, dispensing carton 10 can be sized to fit in a package having a length of approximately 10 inches, a width of approximately 5 inches, and a height of approximately 7.25 inches. In an aspect, dispensing carton 10 can be sized to fit in a two pound or three pound dimensional weight package along with other mailing items.

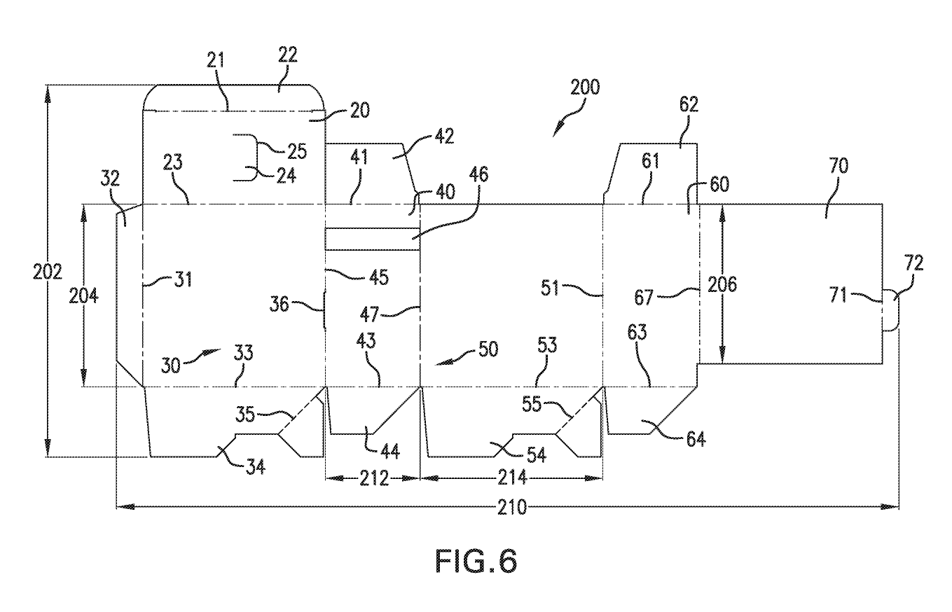

Referring now to FIG. 6, dispensing carton 10 can be formed from a single blank 200. Blank 200 is formed from a foldable sheet of material, such as paperboard. Blank 200 comprises a side flap 32, a first side panel 30, a top panel 20, a top flap 22, a first bottom flap 34, a front panel 40, a front bottom flap 44, a front top flap 42, a second side panel 50, a second bottom flap 54, a back panel 60, a back top flap 62, a back bottom flap 64, a privacy panel 70, and a privacy flap 72.

First side panel 30 can be foldably connected to side flap 32 by a first transverse fold line 31, top panel 20 by second longitudinal fold line 23, first bottom flap 34 by third longitudinal fold line 33, and front panel 40 by second transverse fold line 45. A portion of second transverse fold line 45 can be cut to form privacy flap slot 36. Top panel 20 can be foldably connected to top flap 22 by first longitudinal fold line 21. Retention member 24 can be formed in top panel 20 by cut line 25. Tear line 35 can extend across a portion of first bottom flap 34.

Front panel 40 can be foldably attached to front top flap 42 by fourth longitudinal fold line 41, front bottom flap 44 by fifth longitudinal fold line 43, and second side panel 50 by third transverse fold line 47. Dispensing slot 46 can be formed in front panel 40, for example, by removing a portion of front panel 40.

Second side panel 50 can be foldably connected to second bottom flap 54 by sixth longitudinal fold line 53 and back panel 60 by fourth transverse fold line 51. Tear line 55 can extend across a portion of second bottom flap 54.

Back panel 60 can be foldably connected to back top flap 62 by seventh longitudinal fold line 61, back bottom flap 64 by eighth longitudinal fold line 63, and privacy panel 70 by fifth transverse fold line 67. Privacy panel 70 can be foldably connected to privacy flap 72 by sixth transverse fold line 71.

Top flap 22, side flap 32, first bottom flap 34, front top flap 42, front bottom flap 44, second bottom flap 54, back top flap 62, and back bottom flap 64 can be folded together to form dispensing carton 10 such that top flap 22, side flap 32, first bottom flap 34, front top flap 42, front bottom flap 44, second bottom flap 54, back top flap 62, and back bottom flap 64 are positioned within interior area 12. In another aspect, the respective flaps can be held together by adhesive or glue.

Dispensing carton 10 and blank 200 can be any size to accommodate a desired article therein. Blank 200 can have a height 202 and a length 210. Height 202 can extend from top flap 22 to first bottom flap 34. In an aspect of the invention, height 202 can range from approximately 8 inches to approximately 16 inches, such as approximately 12.237 inches. Length 210 can extend from side flap 32 to privacy flap 72. In an aspect, length 210 can range from approximately 15 inches to approximately 35 inches, such as approximately 25 and 23/32 inches.

First side panel 30, front panel 40, second side panel 50, and back panel 60 can have a height 204. Front panel 40 and back panel 60 can have a width 212. In an aspect, width 212 can range from approximately 0.5 inch to approximately 6 inches, such as approximately 3 and ⅛ inches.

First side panel 30 and second side panel 50 can have a length 214. In an aspect, length 214 can range from approximately 2 inches to approximately 10 inches, such as approximately 6 inches.

Privacy panel 70 can have a height 206. In an aspect, height 206 can be equal to height 204. In another aspect, height 206 can be less than height 204. Height 206 can range from approximately 2 inches to approximately 10 inches, such as approximately 5 and ¼ inches. Privacy panel 70 can have a length equal to length 214 so privacy flap 72 can engage privacy flap slot 36 to cover at least a portion of first side panel 30.

The blanks according to an aspect present invention can be, for example, formed from coated paperboard and similar materials. In accordance with the above-described embodiments, the blank may be constructed of paperboard that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections. The blank may also include decorative graphics to make the carton more attractive when it is in use.

In accordance with the above-described embodiments of the present invention, a fold line can be any substantially linear, although not necessarily straight, form of weakening that facilitates folding therealong. More specifically, but not for the purpose of narrowing the scope of the present invention, fold lines can include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present invention for each of the tear lines to be replaced with a continuous slit, or the like. For example, a cut line can be a continuous slit or could be wider than a slit without departing from the present invention.

It is to be appreciated that the Detailed Description section, and not the Summary and Abstract sections, is intended to be used to interpret the claims. The Summary and Abstract sections may set forth one or more but not all exemplary embodiments of the present invention(s) as contemplated by the inventor(s), and thus, are not intended to limit the present invention(s) and the appended claims in any way.

The present invention(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The foregoing description of the specific embodiments will so fully reveal the general nature of the invention(s) that others can, by applying knowledge within the skill of the art, readily modify and/or adapt for various applications such specific embodiments, without undue experimentation, without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention(s) should not be limited by any of the above-described exemplary embodiments, but should be defined only in accordance with the following claims and their equivalents.

1. A dispensing carton comprising:
a unitary carton blank including a front panel, a back panel, a top panel, a first side panel, a second side panel, and a bottom flap, the front panel, back panel, top panel, first side panel, second side panel, and bottom flap forming an interior of the dispensing carton;
a dispensing slot formed in one of the front panel and back panel for dispensing contents of a dispensing roll disposed in the dispensing carton; and
a cut line integrally formed in the top panel and forming a tab having a fixed end integrally formed in the top panel and a free end extending from the fixed end, the tab configured to hold an end of a dispensing roll positioned within the interior of the carton,
wherein a first end of the cut line is spaced from a longitudinal side of the top panel.

2. The dispensing carton of claim 1, wherein the dispensing slot is formed in the front panel.

3. The dispensing carton of claim 2, wherein the tab is configured to exert a normal force on the end of the dispensing roll to hold the end against an exterior surface of the top panel,
wherein a first side of the tab connected to the fixed end is positioned at approximately 90 degrees to the free end, and
wherein a second side of the tab connected to the fixed end is positioned at approximately 90 degrees to the free end.

4. The dispensing carton of claim 2, wherein the tab has a “U” shape.

5. The dispensing carton of claim 1, further comprising a privacy panel connected to and configured to cover at least one of the front panel; back panel; and first side panel.

6. The dispensing carton of claim 5, wherein a height of the privacy panel is equal to a height of the one of the front panel; back panel; and first side panel.

7. The dispensing carton of claim 5, wherein a height of the privacy panel is less than a height of the one of the front panel, back panel, and first side panel.

8. The dispensing carton of claim 5, further comprising a privacy flap connected to the privacy panel,
and a privacy flap slot positioned between the front panel and the first side panel, wherein the privacy flap is configured to engage the privacy flap slot.

9. A unitary carton blank comprising:
a top panel;
a first side panel connected to the top panel by a first longitudinal fold line;
a front panel connected to the first side panel by a first transverse fold line;
a second side panel connected to the front panel by a second transverse fold line;
a back panel connected to the second side panel by a third transverse fold line;
a dispensing slot formed in the front panel;
a cut line in the top panel, the cut line forming a retention tab to hold an end of a dispensing roll;
a side flap connected to the first side panel by a fourth transverse fold line;
a top flap connected to the top panel by a second longitudinal fold line;
a first bottom flap connected to the first side panel by a third longitudinal fold line;
a front top flap connected to the front panel by a fourth longitudinal fold line;
a front bottom flap connected to the front panel by a fifth longitudinal fold line;
a second bottom flap connected to the second side panel by a sixth longitudinal fold line;
a back top flap connected to the back panel by a seventh longitudinal fold line; and
a back bottom flap connected to the back panel by an eighth longitudinal fold line.

10. (canceled)

11. The unitary carton blank of claim 9, further comprising:
a privacy panel connected to the back panel by a fourth transverse fold line;
a privacy panel flap connected to the privacy panel by a fifth transverse fold line; and
a privacy panel slot formed along a portion of the first transverse fold line.

12. The unitary carton blank of claim 11, wherein a height of the privacy panel is equal to a height of the back panel.

13. The unitary carton blank of claim 11, further comprising:
a side flap connected to the first side panel by a sixth transverse fold line;
a top flap connected to the top panel by a second longitudinal fold line;
a first bottom flap connected to the first side panel by a third longitudinal fold line;
a front top flap connected to the front panel by a fourth longitudinal fold line;
a front bottom flap connected to the front panel by a fifth longitudinal fold line;
a second bottom flap connected to the second side panel by a sixth longitudinal fold line;
a back top flap connected to the back panel by a seventh longitudinal fold line; and
a back bottom flap connected to the back panel by an eighth longitudinal fold line.

14. The carton blank of claim 10, wherein the cut line includes a curve.

15. The carton blank of claim 10, wherein the dispensing slot is formed in the front panel.

16. (canceled)

17. (canceled)

18. A unitary carton blank comprising:
a top panel;
a first side panel connected to the top panel by a first longitudinal fold line;
a front panel connected to the first side panel by a first transverse fold line;
a second side panel connected to the front panel by a second transverse fold line;
a back panel connected to the second side panel by a third transverse fold line;
a dispensing slot formed in the front panel;
a cut line in the top panel, the cut line forming a retention member to hold an end of a dispensing roll;
a privacy panel connected to the back panel by a fourth transverse fold line for covering at least an exterior portion of the first side panel;
a privacy panel flap connected to the privacy panel by a fifth transverse fold line; and
a privacy panel slot formed along a portion of the first transverse fold line.

19. A dispensing carton comprising:
a front panel; a back panel, a top panel, a first side panel, a second side panel, and a bottom flap extending at least partially around an interior of the carton;
a dispensing slot formed in the front panel;
a cut line integrally forming a retention tab in the top panel, the retention tab being configured to hold an end of a dispensing roll positioned within the interior of the carton such that the tab is configured to exert a normal force on the end of the dispensing roll to hold the end against an exterior surface of the top panel; and
a privacy panel connected to the front panel and configured to cover at least an exterior portion of the front panel,
wherein a first end of the cut line is spaced from a longitudinal side of the top panel,
wherein a second end of the cut line is spaced from a second longitudinal side of the top panel, and
wherein a distance between the first end of the cut line and the second end of the cut line is less than a width of the top panel.

20. The dispending carton of claim 19, further comprising:
a privacy panel flap connected to the privacy panel; and
a privacy panel flap slot formed adjacent the front panel to receive the privacy panel flap to maintain the privacy panel in a closed position.

21. A method of forming a dispensing carton, the method comprising:
obtaining a blank comprising a plurality of panels and a plurality of flaps, the plurality of panels and the plurality of flaps including:
a top panel having a cut line to form a retention tab to hold an end of a dispensing roll against an exterior surface of the top panel, a first side panel foldably connected to the top panel, a front panel foldably connected to the first side panel, a second side panel foldably connected to the front panel, a back panel foldably connected to the second side panel, a side flap foldably connected to the first side panel, a top flap foldably connected to the top panel, a first bottom flap foldably connected to the first side panel, a front top flap foldably connected to the front panel, a front bottom flap foldably connected to the front panel, a second bottom flap foldably connected to the second side panel, a back top flap foldably connected to the back panel, and a back bottom flap foldably connected to the back panel;
positioning the plurality of panels and the plurality of flaps to form an interior of the carton; and
positioning the retention tab such that a free end extends outward from the exterior surface of the top panel.

22. The dispensing carton of claim 1, wherein a second end of the cut line is spaced from a second longitudinal side of the top panel.

23. The dispensing carton of claim 22, wherein a distance between the first end of the cut line and the second end of the cut line is less than a width of the top panel.
